(19) United States
(12) Patent Application Publication
(10) Pub. No.: US 2023/0072468 A1
(43) Pub. Date: Mar. 9, 2023

(54) ION SEPARATOR

(71) Applicant: POSTECH Research and Business Development Foundation, Pohang-si (KR)

(72) Inventors: Geunbae LIM, Gyeongju-si (KR); Woo Chul J. JUNG, Pohang-si (KR); Hyukjin J. KWON, Yongin-si (KR); Minsoo LEE, Incheon (KR)

(21) Appl. No.: 17/940,182

(22) Filed: Sep. 8, 2022

(30) Foreign Application Priority Data
Sep. 9, 2021 (KR) 10-2021-0120551
Sep. 9, 2021 (KR) 10-2021-0120552
Nov. 12, 2021 (KR) 10-2021-0156088

(51) Int. Cl. B01J 47/127; B01D 69/12

(52) U.S. Cl. CPC B01J 47/127; B01D 69/12

(57) ABSTRACT

An ion separator according to an embodiment of the present invention includes: a first electrode buffer channel and a second electrode buffer channel; a main channel that connects between the first electrode buffer channel and the second buffer channel; a first ion exchange membrane positioned between the first electrode buffer channel and the main channel; a porous second ion exchange membrane that is provide across the main channel and contains pores of different sizes; a first electrode electrically connected to the main channel with the first electrode buffer channel in between; and a second electrode electrically connected to the main channel with the second electrode buffer channel in between, wherein the second ion exchange membrane may be inserted into the main channel while being inclined toward a fluid flowing through the main channel.

### TECHNICAL FIELD

The present invention relates to an ion separator. More particularly, the present invention relates to an ion separator that uses an ion exchange membrane.

### BACKGROUND ART

Selective electrodialysis (S-ED) is a method that uses an ion exchange membrane to separate two different ions present in a fluid. When a voltage is applied, an electrical double layer (EDL) is formed by opposite polarity charges (counter ions) in a charge group of a monovalent ion exchange membrane including a specific charge group (sulfonic acid radicals) on the surface is formed at an interface between the monovalent ion exchange membrane and an electrolyte solution.

In the process of forming the electrical double layer, since divalent ions are preferentially absorbed into the charge group of the monovalent ion exchange membrane compared to monovalent ions, a large amount of divalent ions accumulate to form an electrical layer at the exchange membrane-electrolyte solution interface. A repulsive force by the electric layer acts on the ions positioned outside the formed divalent ion electric layer, and a smaller repulsive force than the divalent ion acts on the monovalent ion due to the difference in charge amount.

As a result, it is more difficult for divalent ions to pass through the exchange membrane through the electric layer than monovalent ions, and monovalent ions preferentially pass through the exchange membrane and are separated from divalent ions.

In such a method, separation occurs along a direction vertical to the flow of the fluid, resulting in membrane fouling of the ion exchange membrane, which reduces the replacement cycle of the ion exchange membrane and increases cost.

In addition, as the ion exchange membrane fouls, the separation efficiency due to membrane fouling decreases, and since only ions having different charge amounts can be separated, it is not easy to selectively separate ions having the same charge amount.

### DISCLOSURE

### Technical Problem

Therefore, the present invention is to provide an ion separator that increases the replacement cycle of the ion exchange membrane by reducing membrane fouling of the ion exchange membrane and does not cause a decrease in separation efficiency due to membrane fouling of the ion exchange membrane.

In addition, it is to provide an ion separator that can easily separate ions having the same charge amount.

### Technical Solution

An ion separator according to an embodiment of the present invention includes: a first electrode buffer channel and a second electrode buffer channel; a main channel that connects between the first electrode buffer channel and the second buffer channel; a first ion exchange membrane positioned between the first electrode buffer channel and the main channel; a porous second ion exchange membrane that is provide across the main channel and contains pores of different sizes; a first electrode electrically connected to the main channel with the first electrode buffer channel in between; and a second electrode electrically connected to the main channel with the second electrode buffer channel in between, wherein the second ion exchange membrane may be inserted into the main channel while being inclined toward a fluid flowing through the main channel.

The second ion exchange membrane may contain nano-sized pores and micro-sized pores.

The second ion exchange membrane may be inclined toward the main channel while being inserted into the main channel and one side of the second ion exchange membrane may face the main channel.

The second ion exchange membrane may be inclined at 30 to 60 degrees with respect to the main channel.

A fine fiber structure may be positioned on one side of the second ion exchange membrane.

The fine fiber structure may be formed by weaving fibers that are irregularly arranged rather than being arranged in a constant direction.

The fine fiber structure may be a non-woven mat.

The ion separator may include a first outlet and a second outlet that are connected with the main channel, wherein the first outlet and second outlet may be respectively positioned on opposite sides with the second ion exchange membrane interposed therebetween.

The main channel may further include a branch channel formed along an inclined surface of the second ion exchange membrane, and the first outlet is formed at an end of the branch channel.

The first ion exchange membrane may contain nano-sized pores.

The first ion exchange membrane may be a negative ion exchange membrane or a positive ion exchange membrane.

The second ion exchange membrane may be an ion exchange membrane of the same polarity as the first ion exchange membrane.

The second electrode buffer channel may be positioned on one side of the second ion exchange membrane positioned outside the main channel.

The ion separator may further include a blocking layer that blocks the fluid flow of the second ion exchange membrane positioned outside the main channel.

### Advantageous Effects

When the ion separator is manufactured as in the embodiment of the present invention, membrane fouling of the ion exchange membrane can be reduced such that the replacement cycle of the ion exchange membrane is increased, thereby reducing the maintenance cost.

In addition, since the solution can be continuously supplied to the main channel through the inlet, ion separation can be performed continuously and quickly.

In addition, a device capable of separating positive ions or negative ions can be manufactured not only in a micro-sized ion separator but also in an ion separator having a millimeter-sized main channel.

### DESCRIPTION OF THE DRAWINGS

FIG. 1 is a photograph of an ion separator manufactured according to an embodiment of the present invention.

FIG. 2 is a schematic perspective view for description of the inside of the ion separator of FIG. 1.

FIG. 3 is a schematic side view for description of the ion separator of FIG. 1.

FIG. 4 is a schematic top plan view for description of the ion separator of FIG. 1.

FIG. 5 is a photograph of a porous positive ion exchange membrane according to an embodiment of the present invention.

FIG. 6 is a photograph of a porous negative ion exchange membrane according to an embodiment of the present invention.

FIG. 7 is a scanning electron microscope (SEM) photograph taken along the VII-VII′ line of FIG. 6.

FIG. 8 is a nanopore transmission electron microscope (TEM) photograph of the porous negative ion exchange membrane of FIG. 6.

FIG. 9 is provided for description of the ion depletion region according to an embodiment of the present invention.

FIG. 10 and FIG. 11 are provided for description of a force acting on the ion approaching the ion depletion region according to an embodiment of the present invention.

FIG. 12 is a fluorescence image of the ion behavior pattern photographed in the ion separator of the present invention according to the flow rate condition.

FIG. 13 is a graph showing the change in ion inflow ratio according to the flow ratio at the first outlet in the ion separator according to the embodiment of the present invention.

FIG. 14 is a graph showing the change in ion inflow ratio according to the flow ratio at the second outlet in the ion separator according to the embodiment of the present invention.

FIG. 15 and FIG. 16 are provided for describing the electrical convection generation pattern in the fine fiber structure according to an embodiment of the present invention.

FIG. 17 is a photograph of a fine fiber structure according to an embodiment of the present invention.

FIG. 18 is a scanning electron microscope (SEM) photograph of the fine fiber structure in FIG. 17.

FIG. 19 (a) is a graph showing an ion influx rate according to the flow rate at the first outlet 22.

FIG. 19 (b) is a graph showing an ion influx rate according to the flow ratio at the second outlet 23.

FIG. 19 (c) is a graph showing r/r₀ and a lithium recovery rate (%) according to the flow rate and rejection rate (%) of magnesium ion according to the flow rate.

FIG. 20 (a) is a graph showing the ion inflow ratio according to the flow ratio in the first outlet 22.

FIG. 20 (b) is a graph showing the ion inflow ratio according to the flow ratio at the second outlet 23.

FIG. 20 (c) is a graph showing dr°, a lithium recovery rate (%), and a magnesium ion rejection rate according to the flow rate.

FIG. 21 (a) is a graph showing the ion inflow ratio according to the flow ratio in the first outlet 22.

FIG. 21 (b) is a graph showing the ion inflow ratio according to the flow ratio at the second outlet 23.

FIG. 21 FIG. 21 (c) is a graph showing r/r₀ according to the flow rate, lithium recovery rate (%) in the second outlet 23, and magnesium rejection rate (%) according to the flow rate.

### MODE FOR INVENTION

Hereinafter, exemplary embodiments of the present invention will be described in detail with reference to the accompanying drawings to allow those skilled in the art to practice the present invention. The present invention may be implemented in various different forms and is not limited to the examples as described herein.

The size and thickness of each component shown in the drawings may be arbitrarily shown for convenience of explanation, and therefore, the present invention is not necessarily limited to the shown exemplary embodiments in the drawings.

In the drawings, the thickness of layers, films, panels, regions, etc., are exaggerated for clarity. In addition, in the drawing, the thickness of some layers and areas is exaggerated for convenience of explanation. It will be understood that when an element such as a layer, film, region, or substrate is referred to as being “on” another element, it can be directly on the other element or intervening elements may also be present.

In addition, unless explicitly described to the contrary, the word “comprise”, and variations such as “comprises” or “comprising” will be understood to imply the inclusion of stated elements but not the exclusion of any other elements.

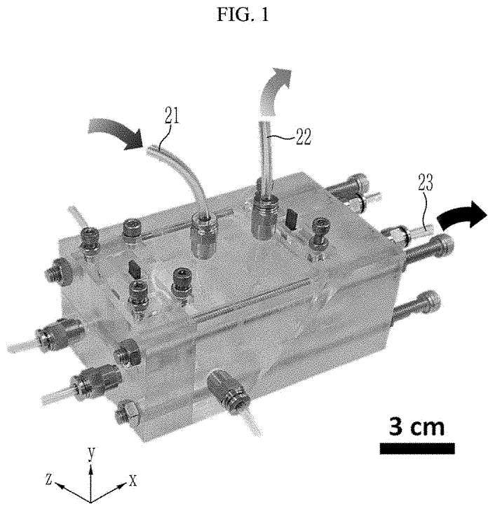

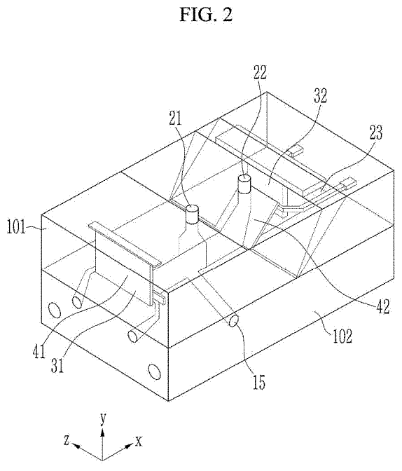

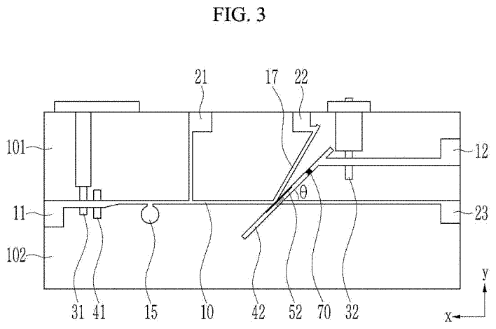

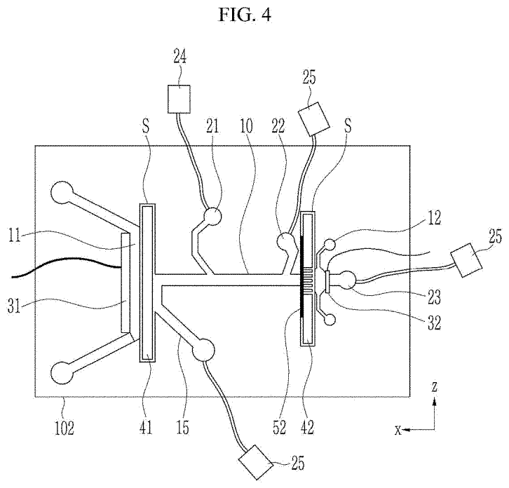

FIG. 1 is a photograph of an ion separator manufactured according to an embodiment of the present invention, FIG. 2 is a schematic perspective view for description of the inside of the ion separator of FIG. 1, FIG. 3 is a schematic side view for description of the ion separator of FIG. 1, and FIG. 4 is a schematic top plan view for description of the ion separator of FIG. 1.

As shown in FIG. 1 to FIG. 4, an ion separator according to an embodiment of the present invention includes an upper frame 101 and a lower frame 102 coupled to face each other. A channel 10 and a slot (not shown), anion exchange membranes 41 and 42 provided in the channel and the slot, a microfiber structure 52 may be installed in the lower frame 102.

A lower slot, a slot corresponding to a channel, and the channel may be formed in the upper frame 101.

The channel 10 is a passage through which a fluid actually flows, and is formed to be concave in the lower frame 102. The slot, which is for fixing a position of the ion exchange membrane installed in the channel, may be fixed in position as the ion exchange membrane is inserted into the lower frame 102 and the upper frame 101 and may be formed to a depth by which the upper frame 101 and the lower frame 102 are not separated after the upper and lower frames are attached.

The upper and lower frames 101 and 102 may be manufactured using polydimetysiloxane (PDMS). For example, PDMS may be injected into a mold manufactured by a 3D printing method and cured, and thereafter, the mold may be removed to manufacture the upper and lower frames 101 and 102. The upper and lower frames 101 and 102 may be irreversibly bonded by an oxygen plasma treatment to prevent leakage between the upper and lower frames by fluid pressure.

The ion exchange membranes 41 and 42 and the microfiber structure 52 may be inserted into the channel 10 and the slots S of the lower frame 102.

After the ion exchange membrane and the microfiber structure are inserted into the slots, the oxygen plasma treatment may be performed on contact surfaces of the upper and lower frames for irreversible bonding. That is, after the ion exchange membrane and the microfiber structure are inserted into the lower frame 102, the upper frame 101 may be aligned and covered, the upper and lower frames are bonded by irreversible bonding by the oxygen plasma treatment, and then, a heat treatment may be performed to increase bonding strength.

Referring to FIG. 3 and FIG. 4, an ion exchange device according to an embodiment of the present invention includes a main channel 10 for treating a solution-type sample and electrode buffer channels 11 and 12 including an electrode. In this case, the main channel 10 and the electrode buffer channels 11 and 12 may be grooves formed in the lower frame. The channel 10 may extend in a first direction X of the lower frame 102.

An inlet 21 and outlets 22 and 23 through which the solution is injected and discharged are formed in the main channel 10. The outlets 22 and 23 include a first outlet 22 and a second outlet 23. A sample reservoir 24 may be connected to the inlet 21, and a syringe pump 25 may be connected to the outlets 22 and 23.

The main channel further includes branch channels that are branched off from the main channel and inclined with respect to the main channel, while being formed along the inclined surface of the second ion exchange membrane. The first outlet 22 is connected to an end of the branch channel, that is, the branch channel 17 may extend from the main channel 10 to a space between the first direction X and a second direction Y, and the second outlet 23 is connected to one end of the main channel 10 such that the fluid can be discharged therethrough in the first direction X.

The fluid may move by applying a negative pressure through the syringe pump 25 connected to the outlets 22 and 23.

The electrode buffer channels 11 and 12 are provided to prevent byproducts occurring due to an electrochemical reaction of the electrodes from flowing into the main channel 10 and adversely affecting the solution treatment, and electrodes 31 and 32 are connected with the main channel 10 through the electrode buffer channels 11 and 12.

The electrode buffer channels 11 and 12 include a first electrode buffer channel 11 connected to the first electrode 31 and a second electrode buffer channel 12 connected to the second electrode 32. The main channel 10 is connected to the first electrode 31 with the first electrode buffer channel 11 interposed therebetween, and the second electrode buffer channel 12 is connected to the second electrode 32 with the second ion exchange membrane 42 (to be described below) located outside the main channel 10 interposed therebetween. The first electrode 31 and the second electrode 32 may be positive or negative depending on the electrical polarity of the ion to be separated.

For example, in the case of processing positive ions, the ion exchange membranes 41 and 42, which will be described later, may be negative ion exchange membranes, and a negative electrode (−) may be connected to the first electrode 31 and a positive electrode (+) may be connected to the second electrode 32. Conversely, in the case of processing negative ions, the ion exchange membranes 41 and 42 may be positive ion exchange membranes, and the positive electrode (+) may be connected to the first electrode 31 and the negative electrode (−) may be connected to the second electrode 32.

A flushing channel 15 is connected to the main channel 10, and a syringe pump 27 is connected to the flushing channel 15.

The flushing channel 15 may be formed to relieve an ion concentration area generated on a surface of the opposite side between the first electrode buffer channel 11 and the ion exchange membrane, that is, a surface of the first ion exchange membrane 31 facing the main channel 10. Ions accumulated in the ion concentration area can be continuously eliminated by generating fluid flow through the flushing channel.

Anion exchange membranes (AEMs) 41 and 42 are installed between the main channel 10 and the electrode buffer channels 11 and 12 to control a fluid flow, such as blocking or permitting a fluid flow therebetween. The ion exchange membranes 41 and 42 may be inserted in a third direction Z across the main channel 10.

The ion exchange membranes 41 and 42 include a first ion exchange membrane 41 positioned between the first electrode buffer channel 11 and the main channel 10 and a second ion exchange membrane 42 positioned between the second electrode buffer channel 12 and the main channel 10. The second ion exchange membrane 42 includes a portion positioned outside the main channel 10 across the main channel 10, and the second electrode buffer channel 12 may be positioned on one side of the second ion exchange membrane 42 positioned outside the main channel 10. In this case, one side of the second ion exchange membrane 42 to which the second electrode buffer channel 12 is connected may be positioned apart from the main channel 10 in the second direction Y.

As described above, the first ion exchange membrane 41 and the second ion exchange membrane 42 may be selected as negative ion exchange membranes or positive ion exchange membranes according to the polarity of ions to be separated.

The first ion exchange membrane 41 is positioned on one side of the main channel 10, that is, between the first electrode buffer channel 41 and the main channel 10. The first ion exchange membrane 41 is a commercially available negative ion exchange membrane or positive ion exchange membrane and may contain nano-pores.

Unlike the first ion exchange membrane 41, which is a commercial ion exchange membrane, the second ion exchange membrane 42 includes pores of various sizes, such as nano-pores as well as micro-pores.

The porous second ion exchange membrane 42 may move fluid as well as ions by various pore sizes. Accordingly, a blocking layer 70 may be formed to block the flow of the fluid such that the fluid does not flow to another place through the second ion exchange membrane 42.

The blocking layer 70 may be formed by positioning the second ion exchange membrane 42 positioned outside the main channel 10 and injecting epoxy with a syringe into an area for blocking the flow of fluid.

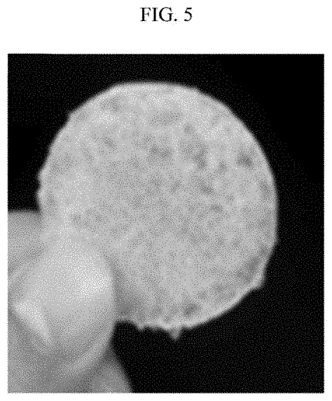

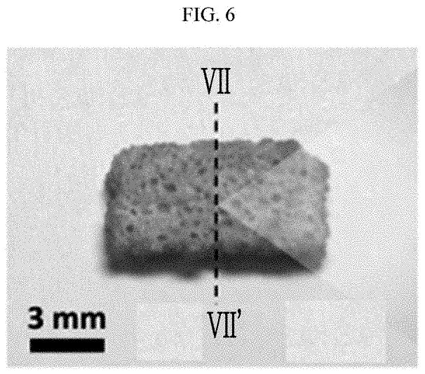

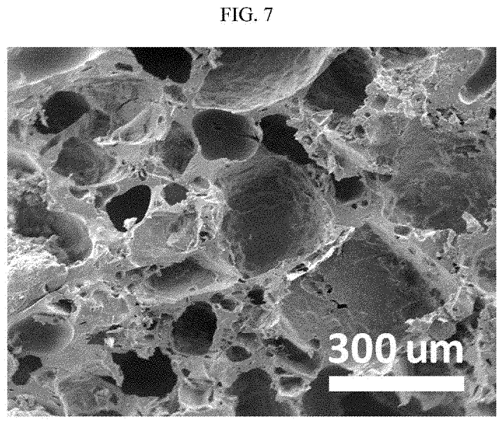

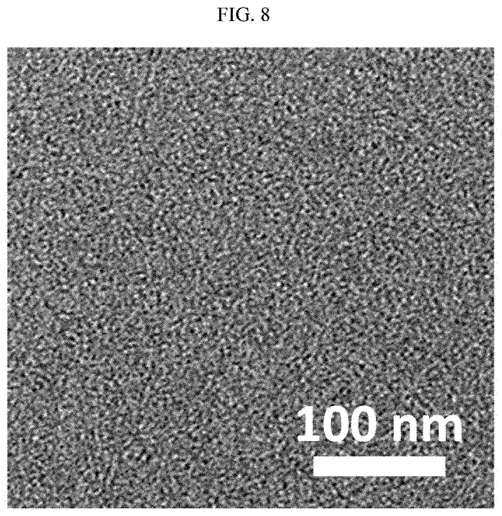

FIG. 5 is a photograph of a porous positive ion exchange membrane according to an embodiment of the present invention, FIG. 6 is a photograph of a porous negative ion exchange membrane according to an embodiment of the present invention, FIG. 7 is a scanning electron microscope (SEM) photograph taken along the VII-VII′ line of FIG. 6, FIG. 8 is a nanopore transmission electron microscope (TEM) photograph of the porous negative ion exchange membrane of FIG. 6.

As shown in FIG. 5 to FIG. 8, it may be confirmed that the second ion exchange membrane, which is a porous positive ion exchange membrane, and the porous negative ion exchange membrane includes not only nano-pores but also pores of various sizes such as micro size. Therefore, the second ion exchange membrane 42 may flow both ions and fluids through pores of various sizes.

The second ion exchange membrane 42 may be manufactured in a desired size and shape by a casting technique. In the casting technique, a polyester resin, PPO−, TMA+ solution, and NaCl powder to form an ion exchange membrane are mixed, poured into a mold, and cured to form a required ion exchange membrane form. Thereafter, a resultant structure is immersed in a deionized water to dissolve NaCl crystals to be removed, so that the first ion exchange membrane 41 having pores having various sizes may be manufactured.

The porous second ion exchange membrane 42 according to an exemplary embodiment of the present invention allows an electric field distribution region (ion depletion region) in the main channel 10 to be induced to the pores serving as channels.

When the second ion exchange membrane 42 is formed as a porous anion exchange membrane including nanopores and micropores, a number of nanopores and micropores may be connected in parallel, achieving an effect that a number of channels are connected in parallel.

That is, a number of nanopores included in the second ion exchange membrane 42 become channels, and an ion depletion region is formed in each channel. In addition, as numerous nanochannels form a parallel-connected structure, the ion depletion regions formed in the respective channels are merged to form an ion depletion region in a channel larger than a millimeter in size. In addition, as a fluid moves into the micropores, an ion depletion region may be formed while continuously injecting a fluid other than a predetermined amount of fluid.

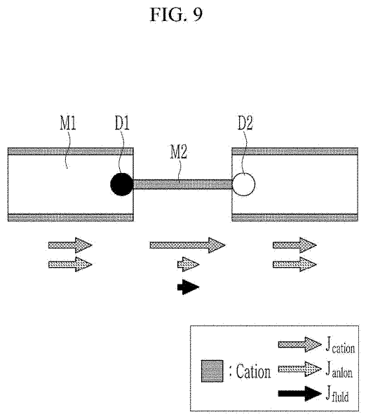

FIG. 9 is provided for description of the ion depletion region according to an embodiment of the present invention.

Referring to FIG. 9, while a microchannel M1 allows both fluid and ions to pass through, a nanochannel M2 selectively allows the flow of ions (counter-ion) of opposite polarity to the electrical polarity applied to the nanochannel. This is because an electrical double layer induced near the wall of the channel and the scale of the nanochannel are similar, and thus the electrical double layer within the channel overlaps. As a result, when the wall surface of the channel is positively charged, only negative ions are selectively allowed to pass therethrough, and when negatively charged, only positive ions are selectively allowed to pass therethrough.

The ion selectivity forms an ion depletion region D1 with very low ion concentration and an ion enriched region D2 with very high ion concentration at both ends of the nanochannel when an electric field is applied to both ends of the nanochannel.

The ion depletion region D1 with low ion concentration acts as electrical resistance, and thus most of the electric field applied to the system is concentrated in the ion depletion region, and the charged particles approaching the ion depletion region receive corresponding electrical force (electrophoretic force) according to electrical polarity and electrophoretic mobility.

Therefore, in an embodiment of the present invention, the porous second ion exchange membrane including the nano-pore and the microchannel is installed such that the nanopore is used as a channel to control the ion depletion region formed in the nanochannel, and accordingly, the ion depletion region formed in the nanochannel is controlled by using the nanopore as a channel, and ions can be separated using the resulting electrophoretic mobility.

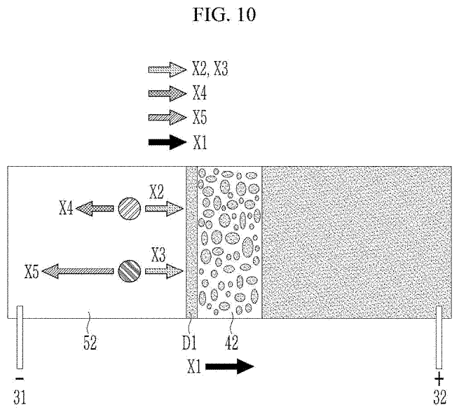

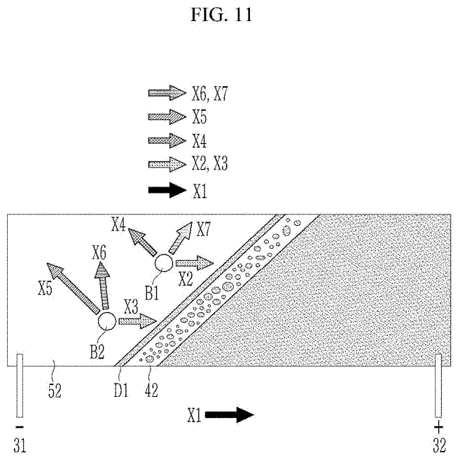

FIG. 10 and FIG. 11 are provided for description of a force acting on the ion approaching the ion depletion region according to an embodiment of the present invention.

Referring to FIG. 10, the porous second ion exchange membrane 42 is a negative ion exchange membrane, and while the second ion exchange membrane 42 is positioned vertical to the fluid flow direction X1, when the negative electrode (−) is applied to the first electrode 31 on the left and the positive electrode (+) is applied to the second electrode 32 on the right centered on the second ion exchange membrane 42, the direction of the electric field and the direction of the fluid flow X1 show a difference of exactly opposite 180 degrees.

In this case, in the positive ions (opposite charge ion of the negative ion exchange membrane) B1 and B2 approaching the ion depletion region D1 formed on the left side of the second ion exchange membrane 42, electrophoretic forces X4 and X5 act in opposite directions to each other opposite to the fluid drag X2 and X3. In the case of fluid-induced drag force, the same magnitude is applied to all types of ions, but the electric forces X4 and X5 act in proportion to the electrophoretic mobility inherent in ions.

Therefore, in the case of the first positive ion B1 having relatively low electrophoretic mobility and the second positive ion B2 having relatively high electrophoretic mobility, resultant forces having the same direction but different magnitudes are generated.

Different ions can be easily separated by changing the direction of the resultant force, and in an embodiment of the present invention, the direction of the resultant force is changed by inserting the second ion exchange membrane at an angle to the main channel (see FIG. 3). That is, the second ion exchange membrane 42 is inclined from the first direction X of the main channel to the second direction Y, and an angle 8 formed by the main channel 10 and the second ion exchange membrane 42 may have an inclination of 30 degrees to 60 degrees. When the inclination angle 8 of the second ion exchange membrane 42 is out of the 30 degrees to 60 degrees inclination, it may not be easy for the separated ions to move to a first outlet or a second outlet.

As shown in FIG. 11, when the second ion exchange membrane 42 is inserted obliquely into the main channel, the electric field in the ion depletion region D1 is also formed obliquely, and the electric forces X4 and X5 acting on the ions also act obliquely along the direction of the electric field.

Therefore, the flow direction of ions is the same as the fluid drag forces X2 and X3, but the action directions of the electric forces X4 and X5 change, narrowing the difference in the action directions of the two forces. In this case, when ions having different electrophoretic mobilities are mixed, a difference in the direction of the resultant forces X6 and X7 occurs due to the difference in electrophoretic mobility of the ions, and as a result, the ions may move in different paths.

As in the ion separator according to the present invention, when the porous second ion exchange membrane is inserted obliquely into the main channel and the flow rate flowing through the main channel and the strength of the electric field are adjusted, ions can be easily separated using the difference in electrophoretic mobility. That is, using the difference in electrophoretic mobility, the ion can be selectively separated by differentiating ions moving to the first outlet 22 positioned at the front end (refer to FIG. 2) and ions moving to the second outlet 23 positioned at the rear end (refer to FIG. 2) centered on the second ion exchange membrane 42.

Ions with high electrophoretic mobility have relatively high repulsive force and are discharged by moving to the first outlet 22 positioned at the front end of the second ion exchange membrane 42, and ions with low electrophoretic mobility have relatively low repulsive force and are discharged by moving to the second outlet 23 positioned at the rear end of the second ion exchange membrane 42. In this case, both different first ions and second ions can be discharged from the first outlet 22 and the second outlet 23, but only some of the first ions or second ions are removed by adjusting the intensity and flow rate of the electric force as needed, and thus the ratio of first ions and second ions discharged from the respective outlets may be changed.

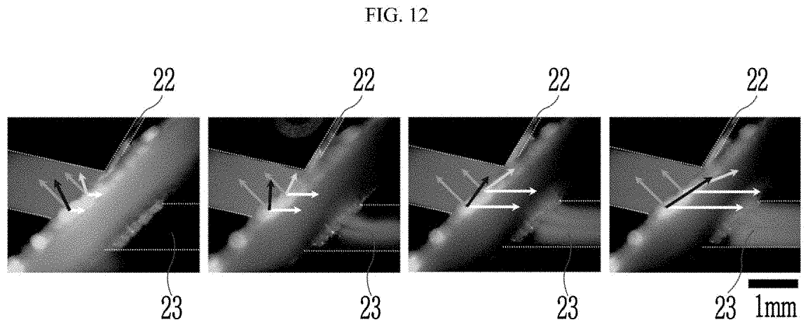

FIG. 12 is a fluorescence image of the ion behavior pattern photographed in the ion separator of the present invention according to the flow rate condition.

Particles in FIG. 11 are red phosphorus particles of Ru(bpy)₃²⁺, the behavior of fluorescent particles moving to the first outlet 22 or the second outlet 23 can be confirmed

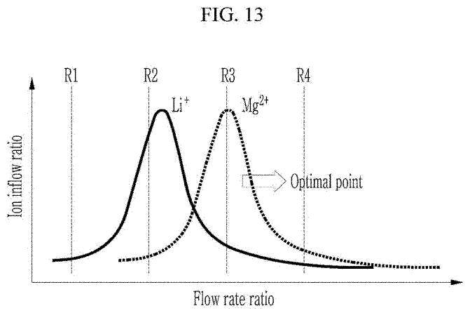

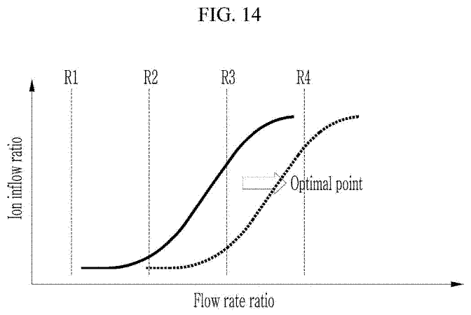

When referring to the behavior of fluorescent particles, when the electrophoretic mobility is different, such as magnesium ion and lithium ion, for the two ions, resultant force X6 and X7 of the two forces change according to the electric forces X4 and X5, and the drag forces X2 and X3 caused by the fluid, and accordingly, magnesium or lithium may be discharged at the first outlet 22 or the second outlet 23 like the behavior of the fluorescent particle. FIG. 13 is a graph showing the change in ion inflow ratio according to the flow ratio at the first outlet in the ion separator according to the embodiment of the present invention, and FIG. 14 is a graph showing the change in ion inflow ratio according to the flow ratio at the second outlet in the ion separator according to the embodiment of the present invention.

The first ion B1 is a lithium ion and has a relatively smaller electrophoretic mobility than the second ion B2, which is a magnesium ion. The ion behavior is controlled by fixing the electric forces X4 and X5 acting on the ions B1 and B2 and changing the drag forces X2 and X3 by the fluid. In addition, the ratio of the flow rate of the first outlet 22 and the second outlet 22 in the main channel is defined as the flow rate ratio, and the behavior is controlled such that the second ion B2 is separated to the first outlet 22 and the first ion B1 is separated to the second outlet 23.

It can be shown in (a) to (d) in FIG. 12, as the flow rate increases, the behavior of ions changes, and the ions may have four different discharge patterns. The four different ion discharge patterns are divided into R1, R2, R3, and R4, respectively.

FIG. 12 (a), which is first pattern R1, is a case that the drag of the fluid is very small compared to the electric force, and ion inflow to the first outlet 22 and the second outlet 23 does not occur at all.

In the case of magnesium ion and lithium ion having different electrophoretic mobilities, a direction of the resultant force acting on the two ions is all formed in a direction of repelling from the ion exchange membrane such that a section of the first mode R1 in which ion discharge is not performed at all can be formed as shown in the ion inflow ratio graph of FIG. 13 and FIG.

Thereafter, a second pattern R2, FIG. 12 (b), the drag of the fluid increases such that ions may be discharged through the first outlet 22 according to electrophoretic mobility with the same intensity as the electric force.

In the case of magnesium ion and lithium ion, which have different electrophoretic mobilities, the direction of the resultant force of the lithium ion, which has a relatively low electrophoretic mobility, is formed toward the first outlet 22 ahead of the direction of the resultant force of the magnesium ion, and the lithium ion moves toward the first outlet 22 and are discharged therethrough. In addition, the magnesium ion is still blocked from moving to the first outlet, and as shown in the ion inflow ratio graph according to the flow rate ratio of FIG. 13 and FIG. 14, the section of the second pattern R2 in which ion discharge does not occur at all may be formed.

Thereafter, a third patterns R3, which is (c) of FIG. 12 shows that when the drag of the fluid further increases, the direction of the resultant force acting on the ions is further inclined, and ions can be discharged through the first outlet 22 and second outlet 23 according to the inclination angle.

In the case of magnesium ion and lithium ion having different electrophoretic mobilities, the direction of the resultant force of magnesium ion having relatively high electrophoretic mobility is formed in the first outlet 22 and thus magnesium ion is discharged through the first outlet, and lithium ion moves to the second outlet 23 by the force of drag and is discharged through the second outlet 23 such that, as shown in the graph of the ion inflow ratio according to the flow rate of FIG. 12 and FIG. 13, a section of a third pattern R3 in which magnesium ion is discharged through the first outlet and lithium is discharged through the second outlet may be formed.

Subsequently, FIG. 12(d), which is a fourth pattern R4, is a case where the drag of the fluid is greatly increased compared to the electric force due to the further increase in drag of the fluid, and all ions are moved to the second outlet and discharged.

Both magnesium ion and lithium ion, which have different electrophoretic mobilities, are discharged through the second outlet, and thus as shown in the ion inflow ratio graph according to the flow rate ratio of FIG. 13 and FIG. 14, a section of the fourth pattern R4 in which ion discharge does not occur at all may be formed.

Referring to FIG. 12, which shows an ion behavior in the first outlet, a section in which the discharge of specific ions increases according to the change in flow rate, and thus different ions can be selectively separated by using this section.

As such, in the ion separator of the embodiment of the present invention, the porous second ion exchange membrane through which fluid can flow is installed and thus ions can be easily separated by using a path that varies depending on the ion based on force without the use of an extractant or filter by using a path that varies depending on the ion.

In the case of ions having the same charge amount, only separation of monovalent ions and n-valent ions was possible when using a conventional monovalent ion exchange membrane. However, since ions are separated using the electrophoretic mobility of ions in the embodiment of the present invention, separation is possible when there is a difference in electrophoretic mobility even though they have the same amount of charge.

Referring back to FIG. 3 and FIG. 4, a fine fiber structure 52 may be installed in front of the second ion exchange membrane 42 to reduce the effect of electrical convection in the main channel 10. The fine fiber structure 52 may be a non-woven mat in which fibers do not have a specific direction.

As in the embodiment of the present invention, the channel may be widened when the porous second ion exchange membrane 42 is installed, but as the channel is widened, a uniform and stable ion depletion region may not be properly formed. This is because strong electroconvection inevitably occurs near the exchange membrane due to electrophoretic instability (EOI) when the size of the main channel increases to a millimeter scale or larger.

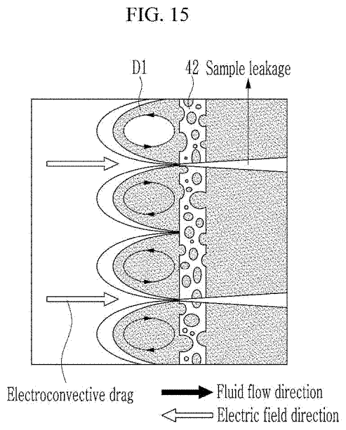

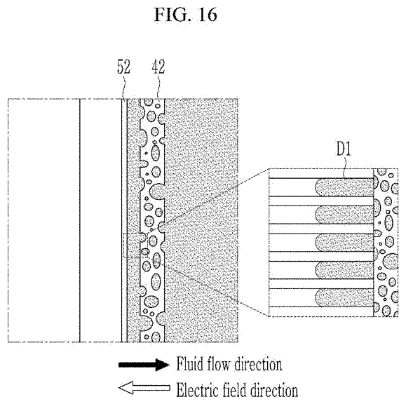

FIG. 15 and FIG. 16 are provided for describing the electrical convection generation pattern in the fine fiber structure according to an embodiment of the present invention.

Referring to FIG. 15, due to the electrical convection, an ion depletion region D1 fluctuating in the form of a semi-sphere is formed in front of the second ion exchange membrane 42, and this may cause leakage of a sample accompanied by electroconvective drag.

Therefore, as shown in FIG. 16, electrical convection can be effectively controlled by installing the fine fiber structure 52 in front of the second ion exchange membrane 42.

When the main channel 10 is increased to a millimeter size, the fine fiber structure 52 may obtain the effect of changing the main channel 10 into numerous fine channels. Therefore, a uniform and stable ion depletion region is formed even in the wide main channel 10 of millimeter size, and leakage of the sample does not occur.

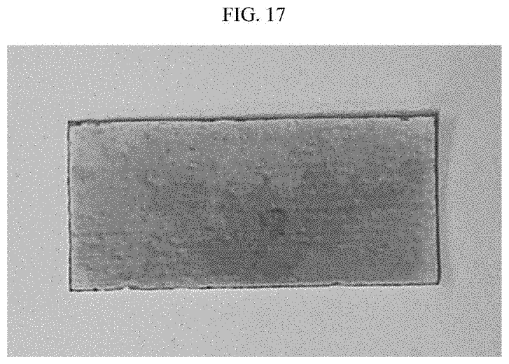

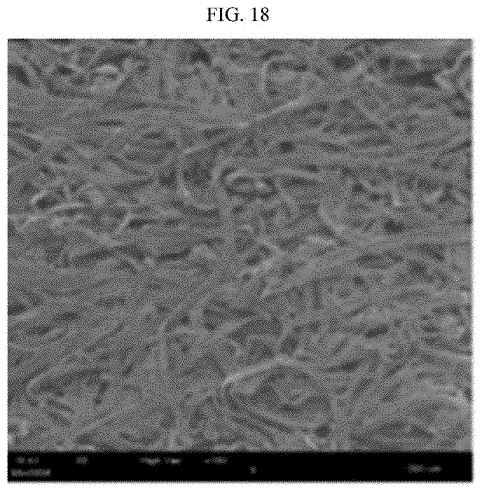

FIG. 17 is a photograph of a fine fiber structure according to an embodiment of the present invention, and FIG. 18 is a scanning electron microscope (SEM) photograph of the fine fiber structure in FIG. 17.

Referring to FIG. 17 and FIG. 18, the fine fiber structure is a structure formed by irregularly intertwining fiber strands of hundreds of nanometers to several micrometers, and contains many effective pores of micro size.

As the nanopores and micropores of the second ion exchange membrane can be regarded as nanochannels and microchannels, the micropore distribution of the microfiber structure can also be regarded as the distribution of microchannels. In this way, when the fine fiber structure is installed on the main channel, one main channel can expect the effect of changing a number of nano channels and micro channels to an in parallel channel structure, thereby uniform synthetic ion depletion region without the occurrence of electrical convection may be formed throughout the channel.

Hereinafter, the result of separating lithium ion and magnesium ion from brine containing lithium ion and magnesium ion using the ion separator according to the embodiment of the present invention will be described with reference to drawing.

Brine is an artificial salt water sample with low electrolyte concentration, containing only lithium ions and magnesium ions, and is separated into lithium ion and magnesium ion through the ion separator shown in FIG. 1 to FIG. 14. In this case, the main channel depth of the ion separator is 0.6 mm, the width of the main channel connected to the first outlet is 0.16 mm, and the width of the main channel connected to the second outlet is 1 mm. The pore diameter of the ion separation membrane is approximately 200 μm, and paraffin wax may be coated to form a blocking layer on a portion where the fluid does not pass to prevent loss due to wetness of the portion where the fluid does not pass in the fine fiber structure.

Density of a current applied to the main channel is j=3 mA/cm², An initial lithium ion concentration (C₀^{Li+}) is 5 mg/L, an initial magnesium ion concentration (C₀^{Mg2+}) is 50 mg/L, a flow rate of the first outlet 22 (refer to FIG. 2 to FIG. 4) is 3 uL/min, a flow rate of the second outlet 23 is 2.5 uL/min to 15.5 uL/min, and r₀, which is an ion ratio of Mg²⁺ with respect to Li⁺ is 10.

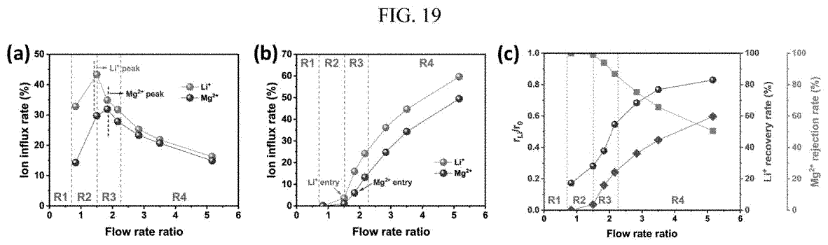

FIG. 19 (a) is a graph showing an ion influx rate according to the flow rate at the first outlet 22, FIG. 19 (b) is a graph showing an ion influx rate according to the flow ratio at the second outlet 23.

Referring to FIG. 19 (a) and FIG. 19 (b), as the flow rate ratio, which is the ratio of the flow rate moving to the first outlet 22 and the second outlet 23, increases, lithium ions inflow to the first and second outlets inflow first, followed by magnesium ions.

That is, as shown in FIG. 13, it can be confirmed that a peak of lithium ion and a peak of magnesium ion appear at different positions according to the flow rate at the first outlet. As such, since the peaks of lithium ion and magnesium ion discharged through the first outlet appear at different flow rates, the ion extracted through the first outlet can be selected by adjusting the flow rate ratio.

FIG. 19 (c) is a graph showing r/r₀ and a lithium recovery rate (%) according to the flow rate and rejection rate (%) of magnesium ion according to the flow rate.

In this case, r/r₀ is (Mg²/Li⁺)/(Mg²/Li⁺) of the initial brine) at a specific flow rate at the second outlet. The magnesium ion rejection rate is the amount of magnesium ions that cannot pass through the second ion exchange membrane. As the rejection rate increases, the amount of ions discharged through the second outlet decreases.

When the flow rate is small, r/r₀ is less than 0.2, and lithium cannot flow into the second outlet such that the lithium recovery rate was approximately 0%. Then, as the flow rate increased, r/r₀ increased to 0.8, and the lithium ion ratio discharged and recovered through the second outlet increased to 60%. This is because the movement of magnesium ions to the second outlet is rejected as the flow rate increases, and magnesium ions are removed by moving to the first outlet.

As such, the graphs of (a) and (b) in FIG. 19 show similar ion behavior compared to the graph of FIG. 13 and FIG. 14.

Therefore, when the ion separator according to the embodiment of the present invention is used, magnesium ions can be separated and removed from brine containing lithium ions and magnesium ions, and the recovery rate of lithium ions can be increased just by adjusting the flow rate.

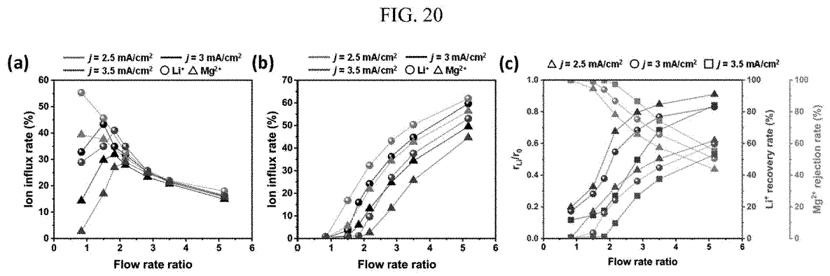

FIG. 20 (a) is a graph showing the ion inflow ratio according to the flow ratio in the first outlet 22, and FIG. 20 (b) is a graph showing the ion inflow ratio according to the flow ratio at the second outlet 23. In this case, the current was measured at 2.5 mA/cm² and 3.5 mA/cm², 3 mA of FIG. 19 was used as a reference.

Referring to FIG. 20 (a) and FIG. 20 (b), when the current is reduced from 3.5 mA/cm² to 325 mA/cm², it can be seen that the ion behavior graph of 3.5 mA/cm² moves to −X axis and +Y axis. This is because that since the intensity of the electric force acting on the ions decreases, the ion synthetic speed direction of rotates to a downstream direction, which is the second outlet, and thus the ions start to inflow to the second outlet from the lower flow rate condition. In addition, as the intensity of the electric force barrier decreases, the ion inflow rate to the first outlet increases.

FIG. 20 (c) is a graph showing dr°, a lithium recovery rate (%), and a magnesium ion rejection rate according to the flow rate.

Referring to FIG. 20 (c), it can be confirmed that r/r₀ increases when the current condition decreases from 3.5 mA/cm² to 2.5 mA/cm².

The electric force acting on a charged particle is linearly proportional to the amount of charge. Therefore, when the current condition decreases from 3.5 mA/cm² to 2.5 mA/cm² and the electrical power decreases, the magnesium ion, which has a relatively large charge amount, has more than twice the reduction in electrical power compared to the lithium ion, which causes a separation gap of the two ions to be reduced.

That is, when lithium ions of the same ratio move to the second outlet, magnesium ions of the much more ratio compared to the high current condition enter, which leads to an increase in Mg²⁺/Li⁺ ratio at the second outlet. As the current condition decreases, the lithium recovery rate also increases, which is the same as the reason for the increase in the ion inflow rate in the second outlet described above.

In case of the magnesium rejection rate according to the increase of the flow rate is decreased at 2.5 mA/cm² compared to the 3.5 mA/cm² current condition corresponding to the change in r/r₀, and decreases from about 1000% to about 40% as the flow rate increased. That is, it can be confirmed that the separation efficiency rapidly decreases as the flow rate increases.

This is because, as the current density decreases, the separation gap interval due to the difference in charge amount between magnesium ion and lithium ion decreases, and as a result, the separation efficiency of magnesium according to the flow rate may be deteriorated.

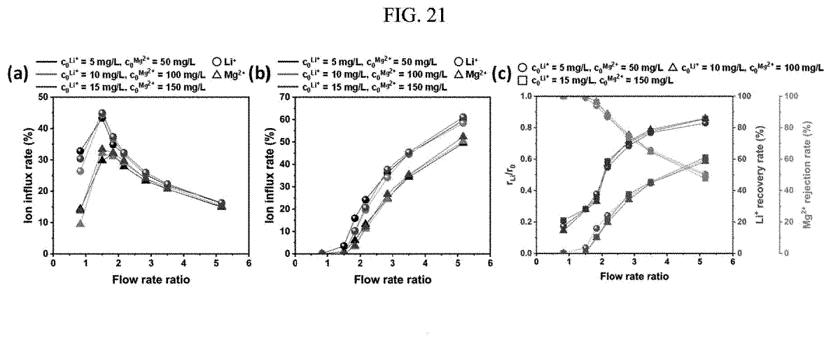

FIG. 21 (a) is a graph showing the ion inflow ratio according to the flow ratio in the first outlet 22, FIG. 21(b) is a graph showing the ion inflow ratio according to the flow ratio at the second outlet 23, and FIG. 21 (c) is a graph showing r/r₀ according to the flow rate, lithium recovery rate (%) in the second outlet 23, and magnesium rejection rate (%) according to the flow rate.

In this case, brine concentration was performed at first concentration, second concentration and third concentration.

Referring to FIG. 21 (a) to (c), it can be confirmed that the graphs of ion influx ratio, r/r₀, lithium ion recovery rate, and magnesium ion rejection rate according to the increase in flow rate ratio are almost similar regardless of the brine concentration.

As such, different ions included in the solution can be easily separated by adjusting the intensity and flow rate of the electric field using the current using the ion separator according to the embodiment of the present invention. In this case, the separation is to appropriately adjust the ratio of ions contained in the solution discharged from each outlet using different outlets rather than completely separating different ions.

The recovery rate of lithium from brine stored in a salt lake can be increased by using the ion separator according to the embodiment of the present invention described above.

With the development of energy storage devices, the demand for lithium is increasing, and a method of recovering lithium from salt lakes is being attempted. In order to recover lithium from salt lakes, a method of naturally and chemically precipitating and removing ions other than lithium is used. However, at the last stage of this process, lithium and magnesium are co-precipitated, resulting in severe loss of lithium. This increases as the ratio of magnesium to lithium increases, and the recovery rate of lithium decreases.

However, the recovery rate of lithium can be increased by removing magnesium ions to an appropriate level by adjusting the flow rate and the intensity of the electric field using the ion separator according to the embodiment of the present invention.

In addition, in the ion separator according to the embodiment of the present invention, the path is changed along the electrophoretic mobility without passing through the ion exchange membrane, and thus after certain ions are partially removed, the fluid passes through the ion exchange membrane such that membrane fouling of the ion exchange membrane can be reduced compared to the convention case where ions are separated by passing through an ion membrane. Therefore, the maintenance cost can be reduced by increasing the replacement cycle of the ion exchange membrane.

In addition, the ion exchange membrane of the ion separator according to the present invention is installed inclined with respect to the direction in which the fluid flows, and thus the ions are separated along the inclination of the ion exchange membrane while the solution in which different ions are mixed moves in the same direction as the flow of the fluid. Therefore, since the solution can be continuously supplied to the main channel through the inlet, ion separation can be performed continuously and quickly.

In addition, as in the present invention, the ion separator can be easily manufactured by inserting and installing a porous ion exchange membrane and a fine fiber structure into a main channel of various shapes and sizes.

In addition, in the embodiment of the present invention, an ion depletion region can be formed throughout the channel along the second ion exchange membrane, and electrical convection occurring in the main channel of a wide size can be suppressed by using a fine fiber structure. Accordingly, a device capable of separating positive or negative ions can be manufactured not only in micro-sized ion separators but also in ion separators with millimeter-sized main channels.

Although the preferred embodiment of the present invention has been described above, the present invention is not limited thereto and can be variously modified and implemented within the scope of the detailed description and accompanying drawing of the patent claims and invention.

1. An ion separator comprising:
a first electrode buffer channel and a second electrode buffer channel;
a main channel that connects between the first electrode buffer channel and the second buffer channel;
a first ion exchange membrane positioned between the first electrode buffer channel and the main channel;
a porous second ion exchange membrane that is provided across the main channel and contains pores of different sizes;
a first electrode electrically connected to the main channel with the first electrode buffer channel in between; and
a second electrode electrically connected to the main channel with the second electrode buffer channel in between,
wherein the second ion exchange membrane is inserted into the main channel while being inclined toward a fluid flowing through the main channel.

2. The ion separator of claim 1, wherein:
the second ion exchange membrane contains nano-sized pores and micro-sized pores.

3. The ion separator of claim 1, wherein:
the second ion exchange membrane is inclined toward the main channel while being inserted into the main channel and one side of the second ion exchange membrane faces the main channel.

4. The ion separator of claim 3, wherein:
the second ion exchange membrane is inclined at about 30 to about 60 degrees with respect to the main channel.

5. The ion separator of claim 1, wherein:
a fine fiber structure is positioned on one side of the second ion exchange membrane.

6. The ion separator of claim 5, wherein:
the fine fiber structure is formed by weaving fibers that are irregularly arranged rather than being arranged in a constant direction.

7. The ion separator of claim 6, wherein:
the fine fiber structure is a non-woven mat.

8. The ion separator of claim 1, comprising:
a first outlet and a second outlet that are connected with the main channel,
wherein the first outlet and second outlet are respectively positioned on opposite sides with the second ion exchange membrane interposed therebetween.

9. The ion separator of claim 8, wherein:
the main channel further comprises a branch channel formed along an inclined surface of the second ion exchange membrane, and the first outlet is formed at an end of the branch channel.

10. The ion separator of claim 1, wherein:
the first ion exchange membrane contains nano-sized pores.

11. The ion separator of claim 1, wherein:
the first ion exchange membrane is a negative ion exchange membrane or a positive ion exchange membrane.

12. The ion separator of claim 11, wherein:
the second ion exchange membrane is an ion exchange membrane of the same polarity as the first ion exchange membrane.

13. The ion separator of claim 1, wherein:
the second electrode buffer channel is positioned on one side of the second ion exchange membrane positioned outside the main channel.

14. The ion separator of claim 13, further comprising:
a blocking layer that blocks the fluid flow of the second ion exchange membrane positioned outside the main channel.
